(19) United States
(12) Patent Application Publication
(10) Pub. No.: US 2015/0168756 A1
(43) Pub. Date: Jun. 18, 2015

(54) LIQUID CRYSTAL FRESNEL LENS AND MANUFACTURING METHOD THEREOF

(71) Applicant: SAMSUNG DISPLAY CO., LTD., Yongin-City (KR)

(72) Inventors: Jung-Hyun Cho, Seoul (KR); Haeyoung Yun, Suwon-si (KR)

(21) Appl. No.: 14/320,870

(22) Filed: Jul. 1, 2014

(30) Foreign Application Priority Data
Dec. 17, 2013 (KR) 10-2013-0157383

(51) Int. Cl. G02F 1/1343; G02F 1/1333

(52) U.S. Cl. CPC G02F 1/1343; G02F 1/133345

(57) ABSTRACT

A liquid crystal Fresnel lens is provided. The liquid crystal Fresnel lens includes first and second substrates facing each other, an insulating layer, lens electrodes, a common electrode, and a liquid crystal layer. The insulating layer is disposed on the first substrate. The lens electrodes are disposed on the first substrate and are spaced apart from each other. The common electrode is disposed on the second substrate. The liquid crystal layer is disposed between the first substrate and the second substrate. The liquid crystal Fresnel lens includes a first region and a second region having cell gaps different from each other.

### CROSS-REFERENCE TO RELATED APPLICATION

This U.S. non-provisional patent application claims priority under 35 U.S.C. §119 to Korean Patent Application No. 10-2013-0157383, filed on Dec. 17, 2013 in the Korean Intellectual Property Office, the disclosure of which is incorporated by reference herein in its entirety.

### TECHNICAL FIELD

The present inventive concept relates to a display device, and more particularly to a liquid crystal Fresnel lens and a manufacturing method thereof.

### DISCUSSION OF THE RELATED ART

A stereoscopic image showing a three-dimensional (3D) image is realized by a stereo view principle through both eyes of an observer. Since both eyes of the observer are spaced apart from each other (e.g., binocular parallax), the left and right eyes see slightly different images from each other by a difference between positions of the both eyes. The image difference caused by the position difference between the left and right eyes is called ‘binocular disparity’. A 3D stereoscopic display device shows a left eye image and a right eye image, respectively, to the left eye and the right eye by the binocular disparity.

For example, the left and right eyes see two-dimensional (2D) images different from each other, and the two different 2D images are transferred to a brain of an observer through their retinas. Thus, the brain merges the transferred images to generate a depth perception and a realistic feeling of an original 3D image. The stereoscopic display device uses stereography to achieve such an effect.

For example, the stereoscopic display device includes an element to separate images provided to the left and right eyes to realize the 3D image. Liquid crystal field lenses (e.g., liquid crystal Fresnel lenses) using a liquid crystal layer may be used to separate the images.

### SUMMARY

According to an exemplary embodiment of the present inventive concept, a liquid crystal Fresnel lens is provided. The liquid crystal Fresnel lens includes a first substrate, a second substrate, an insulating layer, a plurality of lens electrodes, a common electrode, a liquid crystal layer, a first region, and a second region. The second substrate is disposed on the first substrate. The insulating layer is disposed on the first substrate. The plurality of lens electrodes is disposed on the first substrate and is spaced apart from each other. A common electrode is disposed on the second substrate. The liquid crystal layer is disposed between the first substrate and the second substrate. The first region and the second region have cell gaps different from each other.

The insulating layer may be formed in the first region but may not be formed in the second region.

The insulating layer may have a first thickness in the first region and a second thickness different from the first thickness in the second region.

The liquid crystal Fresnel lens may include a plurality of lens regions, and widths of the lens regions may become smaller as distances between the lens regions and a center of liquid crystal Fresnel lens become greater.

Each of the lens regions may include a plurality of sub-regions, and widths of the sub-regions may become smaller as distances between the sub-regions and the center of liquid crystal Fresnel lens become greater.

Each of the lens electrodes may correspond to each of the sub-regions, and widths of the lens electrodes and distances between the lens electrodes may become smaller as distances between the lens electrodes and the center of liquid crystal Fresnel lens become greater.

The insulating layer may include a first insulating layer and a second insulating layer. The first insulating layer may be formed on the first substrate. The second insulating layer may be disposed on the first insulating layer.

The lens electrodes may include a plurality of first lens electrodes and a plurality of second lens electrodes. The plurality of first lens electrodes may be disposed between the first and second insulating layers, may be arranged in a first direction, and may be spaced apart from each other. The second lens electrodes may be disposed on the second insulating layer, may be arranged in the first direction, and may be spaced apart from each other.

The second insulating layer may be formed in the first region but may not be formed in the second region.

The second insulating layer may have a first thickness in the first region and a second thickness different from the first thickness in the second region

The first lens electrodes and the second lens electrodes may not overlap each other and may be alternately arranged in the first direction.

According to an exemplary embodiment of the present inventive concept, a method of manufacturing a liquid crystal Fresnel lens is provided. The method includes preparing a preliminary liquid crystal Fresnel lens having a first cell gap, analyzing a phase distribution of the preliminary liquid crystal Fresnel lens, determining a second cell gap and a first region of the preliminary liquid crystal Fresnel lens in which the first cell gap will be changed into the second cell gap based on the analyzed phase distribution of the preliminary liquid crystal Fresnel lens, and forming the liquid crystal Fresnel lens having the second cell gap different from the first cell gap in the first region.

The analyzing of the phase distribution of the preliminary liquid crystal Fresnel lens may include simulating a designed data value of the preliminary liquid crystal Fresnel lens or measuring a phase distribution of a test product of the preliminary liquid crystal Fresnel lens.

The first region may be determined by detecting a position in which a difference between the phase distribution of the preliminary liquid crystal Fresnel lens and a reference phase is greater than a predetermined reference value.

The forming of the liquid crystal Fresnel lens may include forming an insulating material layer having a uniform thickness on a first substrate, patterning a portion of the insulating material layer corresponding to the first region to form an insulating layer having different thicknesses from each other in the first region and a second region, forming one or more lens electrodes on the first substrate, forming a common electrode on a second substrate, and forming a liquid crystal layer between the first substrate and the second substrate.

The forming of the liquid crystal Fresnel lens may include forming an insulating material layer having a uniform thickness on a first substrate, removing a portion of the insulating material layer corresponding to the first region to form an insulating layer, forming one or more lens electrodes on the first substrate, forming a common electrode on a second substrate, and forming a liquid crystal layer between the first substrate and the second substrate.

A difference between a phase caused by the second cell gap and a reference phase in the first region may be smaller than a difference between a phase caused by the first cell gap and the reference phase in the first region.

According to an exemplary embodiment of the present inventive concept, a display device is provided. The display device includes a liquid crystal Fresnel lens and a display panel. The liquid crystal Fresnel lens includes a first region, a second region, and a liquid crystal layer. The first and second regions are arranged in a first direction. The liquid crystal layer has a first cell gap in the first region and a second cell gap in the second region. The first and second cell gaps are different from each other. An arrangement state of the liquid crystal layer is changed by an electric field applied to the liquid crystal layer.

The liquid crystal Fresnel lens may further include an insulating layer on which the liquid crystal layer is disposed. The first and second cell gaps may be adjusted by changing thicknesses of the insulating layer in the first and second regions.

The liquid crystal Fresnel lens may further include an insulating layer. The insulating layer may be formed in the first region but may not be formed in the second region.

The liquid crystal Fresnel lens may further include a first substrate, a second substrate, a plurality of lens electrodes, and a common electrode. The second substrate may face the first substrate. The plurality of lens electrodes may be disposed on the first substrate and may be spaced apart from each other. The common electrode may be disposed on the second substrate.

### BRIEF DESCRIPTION OF THE DRAWINGS

The above and other features of the present inventive concept will become more apparent by describing in detail exemplary embodiments thereof with reference to the accompanying drawings of which:

FIG. 1A is a cross-sectional view illustrating a liquid crystal Fresnel lens according to an exemplary embodiment of the present inventive concept;

FIG. 1B is a plan view illustrating a lens electrode formed on a first substrate of FIG. 1A, according to an exemplary embodiment of the present inventive concept;

FIGS. 2 and 3 are cross-sectional views illustrating a portion of a lens region of FIG. 1A, according to exemplary embodiments of the present inventive concept;

FIG. 4 is a cross-sectional view illustrating a portion of a liquid crystal Fresnel lens, according to an exemplary embodiment of the present inventive concept;

FIG. 5 is a graph illustrating phase distributions of first and second preliminary liquid crystal Fresnel lenses having first and second cell gaps, respectively, and a reference phase for comparison, according to an exemplary embodiment of the present inventive concept;

FIG. 6 is a graph illustrating phase errors of the first and second preliminary liquid crystal Fresnel lenses of FIG. 5, according to an exemplary embodiment of the present inventive concept;

FIG. 7 is a cross-sectional view illustrating a liquid crystal Fresnel lens in which the first cell gap is changed to the second cell gap in a first region, according to an exemplary embodiment of the present inventive concept;

FIG. 8 is a graph illustrating a reference phase, the phase distributions of the first and second liquid crystal Fresnel lenses, and a phase distribution of the first liquid crystal Fresnel lens after phase compensation according to an exemplary embodiment of the present inventive concept; and

FIG. 9 illustrates a diffraction efficiency of the first liquid crystal Fresnel lens after phase compensation according to an exemplary embodiment of the present inventive concept.

### DETAILED DESCRIPTION OF THE EMBODIMENTS

Exemplary embodiments of the present inventive concept will now be described more fully hereinafter with reference to the accompanying drawings. The present inventive concept may, however, be embodied in many different forms and should not be construed as being limited to the embodiments set forth herein.

As used herein, the singular terms “a,” “an” and “the” are intended to include the plural forms as well, unless the context clearly indicates otherwise.

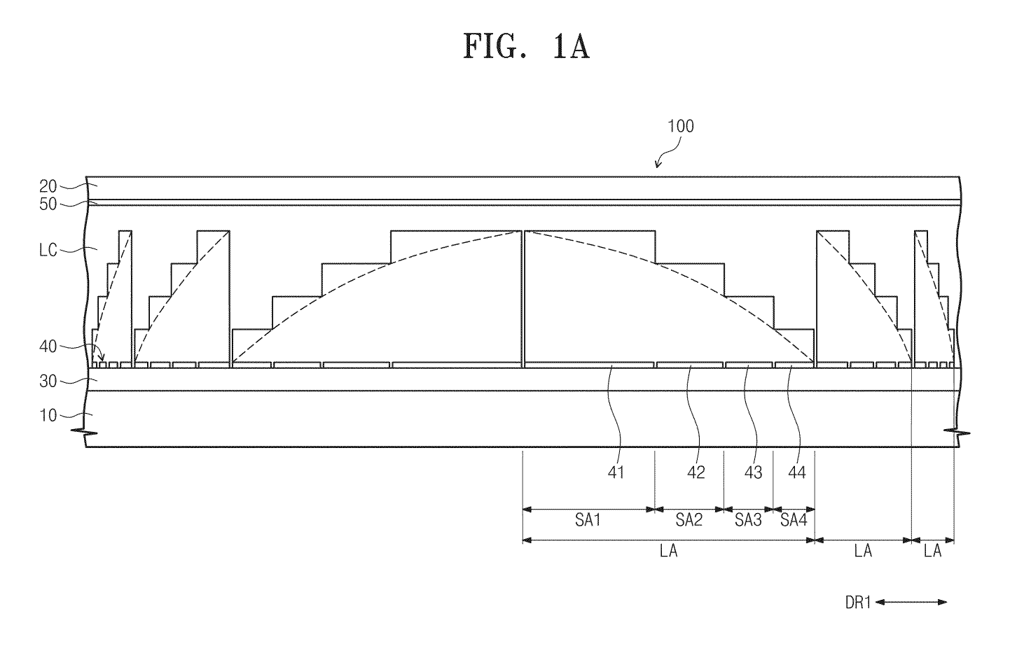

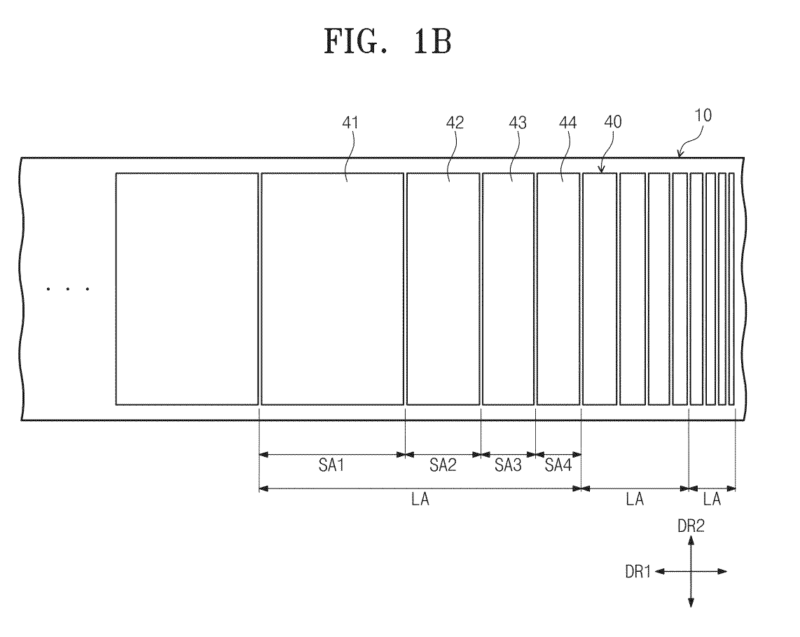

FIG. 1A is a cross-sectional view illustrating a liquid crystal Fresnel lens 100 according to an exemplary embodiment of the present inventive concept, and FIG. 1B is a plan view illustrating a lens electrode formed on a first substrate of FIG. 1A.

Here, a liquid crystal Fresnel lens of the present inventive concept has a function of converting a two-dimensional (2D) image signal into a three-dimensional (3D) image signal according to a profile of a surface of the lens. The liquid crystal Fresnel lens is disposed on a display panel generating the 2D image signal. The liquid crystal Fresnel lens selectively outputs the 3D image signal or the 2D image signal according to whether a voltage is applied to the liquid crystal Fresnel lens. For example, when the voltage is not applied to the liquid crystal Fresnel lens, the liquid crystal Fresnel lens may display the 2D image signal. When the voltage is applied to the liquid crystal Fresnel lens, the liquid crystal Fresnel lens may display the 3D image signal. Thus, the liquid crystal Fresnel lens may have a switching function of selectively displaying one of the 2D image signal and the 3D image signal.

The liquid crystal Fresnel lens 100 includes a first substrate 10, a second substrate 20, an insulating layer 30, a lens electrode 50, a common electrode 50, and a liquid crystal layer LC.

The first substrate 10 and the second substrate 20 may face each other. Each of the first and second substrates 10 and 20 may be an insulating substrate.

The first and second substrates 10 and 20 may include a plurality of lens regions LA. The lens region LA is a unit region in which a liquid crystal layer LC has a lens function according to an electric field that is generated by a voltage applied to the lens electrode 40 and the common electrode 50.

Each of the first and second substrates 10 and 20 may have a first side extending in a first direction DR1 and a second side that is adjacent to the first side and extends in a second direction DR2 intersecting with the first direction DR1.

Widths of the lens regions LA may become progressively smaller as distances between the lens regions and the center of the liquid crystal Fresnel lens 100 become greater.

The lens region LA may include a plurality of sub-regions SA1 to SA4. The plurality of sub-regions SA1 to SA4 may be arranged in the first direction DR1 to be adjacent to each other. FIGS. 1A and 1B illustrate the lens region LA having four sub-regions SA1 to SA4. However, the present inventive concept is not limited thereto. Voltage levels applied to the sub-regions SA1 to SA4 may be different from each other. Thus, magnitudes of electric fields generated in the sub-regions SA1 to SA4 may be different from each other. Widths of the sub-regions (e.g., SA1 to SA4) in each lens region LA may become progressively smaller as the distances between the sub-regions and the center of the liquid crystal Fresnel lens 100 become greater.

The insulating layer 30 is disposed on the first substrate 10. The insulating layer 30 may prevent a parasitic capacitance from being generated between the lens electrode 40 (or the common electrode 50) and electrodes provided on a display panel that may be disposed under the first substrate 10. In addition, a thickness (hereinafter, referred to as ‘a cell gap’) of the liquid crystal layer LC may be controlled for each region of the liquid crystal layer LC. To this end, a thickness of the insulating layer 30 may be formed differently from each other for each region of the liquid crystal layer LC. This will be described in more detail later.

The lens electrode 40 is formed on the first substrate 10 and the insulating layer 30. For example, the lens electrode 40 may be provided in plural in each lens region LA, and the plurality of lens electrodes 40 in each lens region LA may be spaced apart from each other. In addition, the lens electrodes 40 may be formed to correspond to each of the sub-regions SA to SA4. The plurality of lens electrodes 40 may be arranged in the first direction DR1 to be adjacent to each other. Each of the lens electrodes 40 may have a shape that extends in the second direction DR2.

For example, the plurality of lens electrodes 40 may include first to fourth lens electrodes 41 to 44 that correspond to the sub-regions SA1 to SA4, respectively. Widths of the lens electrodes 41 to 44 and distances between the lens electrodes 41 to 44 may become progressively smaller from the first lens electrode 41 to the fourth lens electrode 44. For example, the widths of the lens electrodes 40 and the distances between adjacent lens electrodes 40 may become progressively smaller as the distance from the center of the liquid crystal Fresnel lens 100 along the first direction DR1 becomes greater.

Different voltages from each other may be applied to the first to fourth lens electrodes 41 to 44, respectively. In an exemplary embodiment of the present inventive concept, the respective voltages applied to the first to fourth lens electrodes 41 to 44 may become progressively smaller from first lens electrode 41 to the fourth electrode 44. For example, the largest voltage may be applied to the first lens electrode 41 in each lens region LA, and the smallest voltage may be applied to the fourth lens electrode 44 in each lens region LA. The voltage applied to the second lens electrode 42 may be smaller than the voltage applied to the first lens electrode 41 and may be greater than the voltage applied to the third lens electrode 43. The voltage applied to the third lens electrode 43 may be greater than the voltage applied to the fourth lens electrode 44.

The common electrode 50 may be disposed on the second substrate 20 to face the lens electrode 40. For example, a single common electrode 50 may be formed on the second substrate 20 and may face a plurality of the lens electrodes 40. A common voltage may be applied to the common electrode 50.

The lens electrode 40 and the common electrode 50 may be formed of transparent electrodes.

The liquid crystal layer LC is disposed between the first substrate 10 and the second substrate 20. The liquid crystal layer LC includes liquid crystal molecules of which an arrangement state is changeable depending on an electric field applied thereto. The liquid crystal layer LC functions as a lens according to the electric field generated between the lens electrode 40 and the common electrode 50.

In FIG. 1A, a solid line illustrated in the liquid crystal layer LC expresses magnitudes of the electric fields generated in the sub-regions SA1 to SA4, and a dotted line illustrated in the liquid crystal layer LC expresses a phase distribution of the liquid crystal layer LC functioning as the lens.

In addition, for example, a seal pattern (not shown) may be formed at edge regions of the first and second substrates 10 and 20 to support the first and second substrates 10 and 20.

In addition, for example, an alignment layer may be formed between the liquid crystal layer LC and the lens electrode 40 and/or between the liquid crystal layer LC and the common electrode 50. An initial alignment state of the liquid crystal layer LC may be determined by the alignment layer.

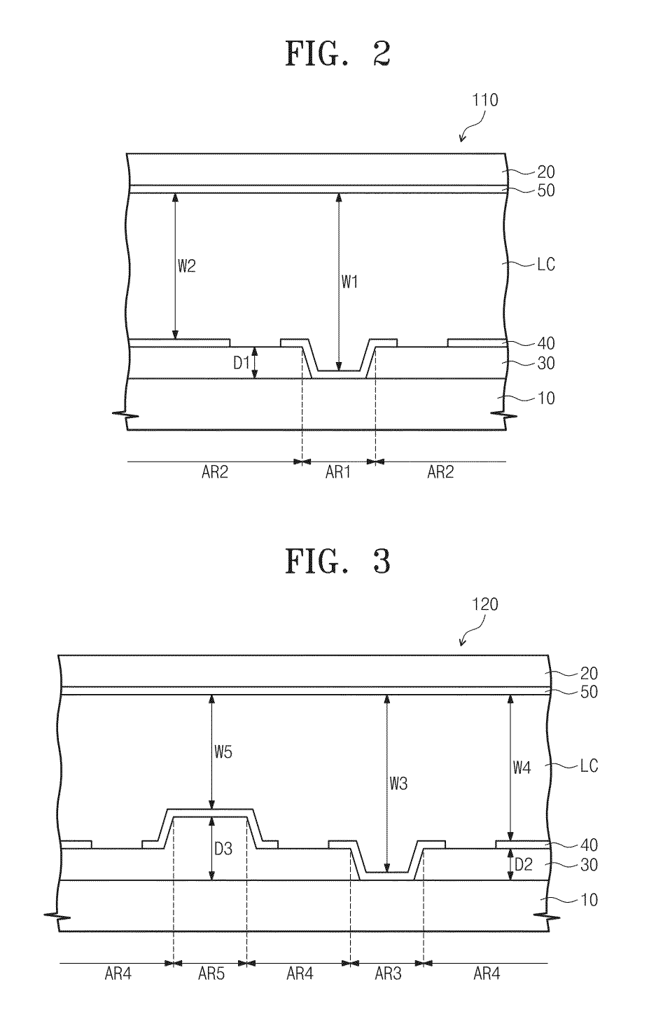

FIGS. 2 and 3 are cross-sectional views illustrating a portion of a lens region of FIG. 1A, according to an exemplary embodiment of the present inventive concept.

Referring to FIG. 2, a liquid crystal Fresnel lens 110 may include a first region AR1 and a second region AR2 that have cell gaps different from each other. Here, the cell gap is a thickness of the liquid crystal layer LC (e.g., a distance between the lens electrode 40 and the common electrode 50) at a particular position.

Each of the first and second regions AR1 and AR2 may overlap with one of the sub-regions SA1 to SA4 or at least two of the sub-regions SA1 to SA4.

The liquid crystal Fresnel lens 110 may have a first cell gap W1 in the first region AR1 and a second cell gap W2 in the second region AR2. In FIG. 2, the first cell gap W1 is illustrated as being greater than the second cell gap W2. However, the present inventive concept is not limited thereto.

For example, the insulating layer 30 may be formed in the second region AR2 having a first thickness D1. The insulating layer 30 may not be formed in the first region AR1. Alternatively, the insulating layer 30 may be formed in the first region AR1 having a second thickness that is smaller than the first thickness D1. FIG. 2 illustrates that the insulating layer 30 is formed in the second region AR2 and is not formed in the first region AR1. However, the present inventive concept is not limited thereto.

Referring to FIG. 3, a liquid crystal Fresnel lens 120 may include a third region AR3, a fourth region AR4, and a fifth region AR5 that have different cell gaps from each other.

Each of the third, fourth, and fifth regions AR3, AR4, and AR5 may overlap with one of the sub-regions SA1 to SA4 or at least two of the sub-regions SA1 to SA4.

The liquid crystal Fresnel lens 120 may have a third cell gap W3 in the third region AR1, a fourth cell gap W4 in the fourth region AR4, and a fifth cell gap W5 in the fifth region AR5. The cell gaps W3, W4, and W5 may become progressively smaller from the third cell gap W3 to the fifth cell gap W5.

For example, the insulating layer 30 formed in the fourth region AR4 may have a second thickness D2, and the insulating layer 30 formed in the fifth region AR5 may have a third thickness D3 greater than the second thickness D2. For example, the insulating layer 30 may not be formed in the third region AR3. Alternatively, the insulating layer 30 may be formed in the third region AR3, and a thickness of the insulating layer 30 in the third region AR3 may be smaller than the second thickness D2. FIG. 3 illustrates that the insulating layer 30 is formed in the fourth and fifth regions AR4 and AR5 and is not formed in the third region AR3. However, the present inventive concept is not limited thereto.

The liquid crystal molecules may be difficult to be controlled in a region between two adjacent lens electrodes 40 of the liquid crystal Fresnel lens 110 or 120, and thus a difference between the phase distribution of the liquid crystal layer LC and a designed reference phase may occur. Thus, a phase error may occur in light passing through the liquid crystal layer LC. The phase distribution of the liquid crystal layer LC may be affected by the cell gap as well as the electric field generated by the lens electrode 40 and the common electrode 50.

According to an exemplary embodiment of the present inventive concept, a region in which the phase error occurs is verified using a simulation result of a designed liquid crystal Fresnel lens or a phase distribution measured from a test product of a liquid crystal Fresnel lens. The cell gap of the liquid crystal Fresnel lens is formed into a cell gap corresponding to a reference phase value in the verified phase error region. To control the cell gap of the liquid crystal Fresnel lens 110 or 120 in the phase error region, the thickness of the insulating layer 30 may be controlled or the insulating layer 30 may be partially removed. Thus, the phase error occurring in a part of the liquid crystal Fresnel lens 110 or 120 may be reduced, and the liquid crystal Fresnel lens 110 or 120 may have a phase distribution designed in all the lens regions LA.

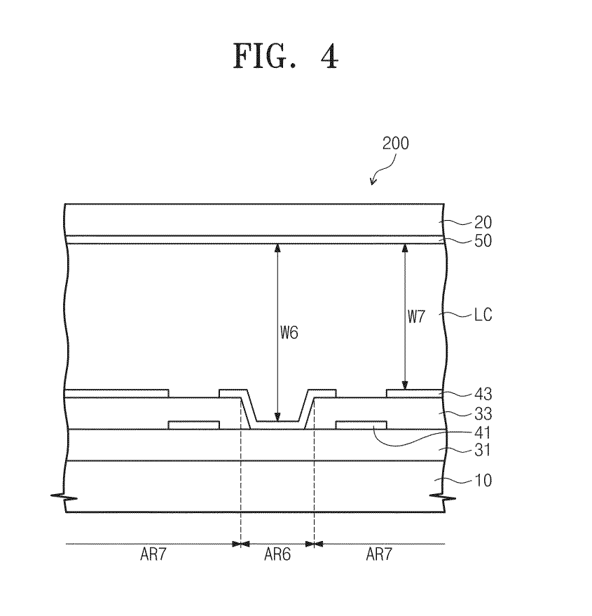

FIG. 4 is a cross-sectional view illustrating a portion of a liquid crystal Fresnel lens according to an exemplary embodiment of the present inventive concept.

A liquid crystal Fresnel lens 200 illustrated in FIG. 4 includes a two-layered lens electrode structure and a two-layered insulating layer structure unlike the liquid crystal Fresnel lens 110 as illustrated in FIG. 2. Other elements of the liquid crystal Fresnel lens 200 may be similar to corresponding elements of the liquid crystal Fresnel lens 110. Differences between the liquid crystal Fresnel lens 200 of FIG. 4 and the liquid crystal Fresnel lens 110 of FIG. 2 will be mainly described hereinafter. Other elements of the liquid crystal Fresnel lens 200 of FIG. 4 will be omitted or mentioned briefly.

Referring to FIG. 4, the liquid crystal Fresnel lens 200 includes a first substrate 10, a second substrate 20, a first insulating layer 31, a second insulating layer 33, a first lens electrode 41, a second lens electrode 43, a common electrode 50, and liquid crystal layer LC.

The first insulating layer 31 is disposed on the first substrate 10.

The first lens electrode 41 is disposed on the first insulating layer 31. The first lens electrode 41 may be provided in plural, and the plurality of first lens electrodes 41 may be spaced apart from each other. For example, the first lens electrodes 41 may be formed to respectively correspond to odd-numbered sub-regions of the sub-regions SA.

The second insulating layer 33 may be disposed on the first lens electrode 41. The second insulating layer 33 electrically insulates the first lens electrode 41 from the second lens electrode 43.

The second lens electrode 43 is formed on the second insulating layer 33. The second lens electrode 43 may be provided in plural, and the plurality of second lens electrodes 43 may be spaced apart from each other. For example, the second electrodes 43 may be formed to respectively correspond to even-numbered sub-regions of the sub-regions SA. The second lens electrodes 43 and the first lens electrodes 41 may not overlap each other and may be arranged to alternately correspond to the sub-regions SA when viewed from a plan view.

The first lens electrode 41 and the second lens electrode 43 may perform substantially the same function as the lens electrode 40 of FIG. 2. Thus, voltages applied to the first and second electrodes 41 and 43 in one lens region may be different from each other.

The liquid crystal Fresnel lens 200 may include a sixth region AR6 and a seventh region AR7 that have cell gaps different from each other.

The liquid crystal Fresnel lens 200 may have a sixth cell gap W6 in the sixth region AR6 and a seventh cell gap W7 in the seventh region AR7. FIG. 4 illustrates that the sixth cell gap W6 is greater than the seventh cell gap W7 as an example. However, the present inventive concept is not limited thereto.

The first insulating layer 31 may be formed to have a uniform thickness. The second insulating layer 33 may be formed in the seventh region AR7, and the second insulating layer 33 in the seventh region AR7 may have a seventh thickness D7. For example, the second insulating layer 33 may not be formed in the sixth region AR6. Alternatively, the second insulating layer 33 may be formed in the sixth region AR6, and the second insulating layer 33 in the sixth region AR6 may have a thickness different from the seventh thickness D7. FIG. 4 shows that the second insulating layer 33 is formed in the seventh region AR7 and is not formed in the sixth region AR6 as an example. However, the present inventive concept is not limited thereto.

According to an exemplary embodiment of the present inventive concept, the first insulating layer 31 as well as the second insulating layer 33 may not be formed in the sixth region AR6 to form a cell gap greater than the sixth cell gap W6 in the sixth region AR6.

A method of manufacturing a liquid crystal Fresnel lens will be described hereinafter.

First, a preliminary liquid crystal Fresnel lens is prepared. The preliminary liquid crystal Fresnel lens has a first cell gap that is uniform throughout the entire region thereof. The preliminary liquid crystal Fresnel lens may be a test product or may exist as a designed data value. In addition, the preliminary liquid crystal Fresnel lens may include the insulating layer 30 of FIG. 1A having a uniform thickness throughout the entire region of the preliminary liquid crystal Fresnel lens. Thus, the preliminary liquid crystal Fresnel lens may have the first cell gap that is uniform throughout the entire region thereof.

Further, a phase distribution of the preliminary liquid crystal Fresnel lens is analyzed. The phase distribution of the preliminary liquid crystal Fresnel lens may be analyzed by simulating the designed data value of the preliminary liquid crystal Fresnel lens or by measuring the test product of the preliminary liquid crystal Fresnel lens.

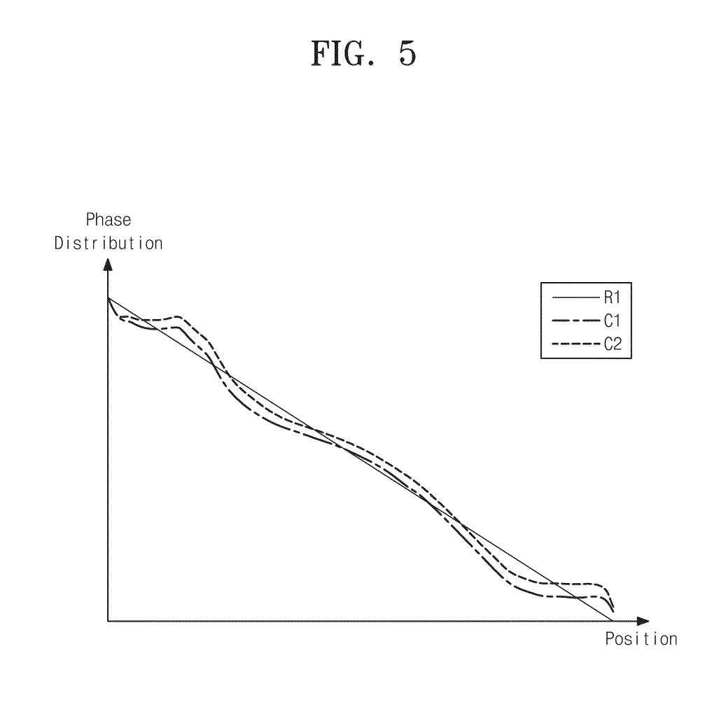

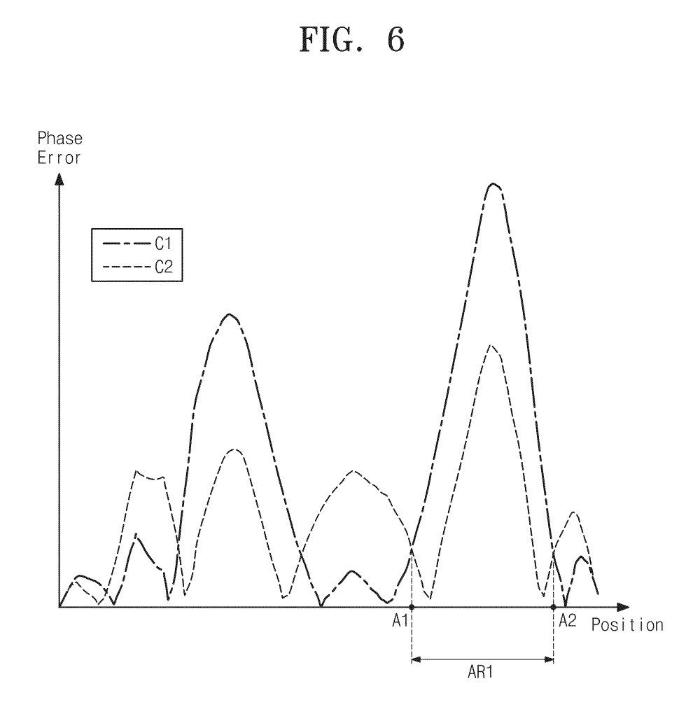

FIG. 5 is a graph illustrating a reference phase and phase distributions of first and second preliminary liquid crystal Fresnel lenses having first and second cell gaps C1 and C2, respectively, and FIG. 6 is a graph illustrating phase errors of the first and second preliminary liquid crystal Fresnel lenses having the first and second cell gaps C1 and C2 of FIG. 5. For example, the first and second preliminary liquid crystal Fresnel lenses may have the first and second cell gap C1 and C2, respectively, that are uniform throughout the entire region thereof.

Here, the first cell gap C1 is less than the second cell gap C2 (C1<C2).

As illustrated in FIGS. 5 and 6, the phase distributions of the first and second preliminary liquid crystal Fresnel lenses are compared with a reference phase R1, and the phase errors of the first and second preliminary liquid crystal Fresnel lenses with respect to the reference phase R1 may be varied depending on the cell gaps C1 and C2. Further, based on the phase distributions of the first and second preliminary liquid crystal Fresnel lenses, a region (e.g., first region AR1 in FIG. 6) in which the first cell gap C1 will be changed and a target cell gap to which the first cell gap will be changed in the region (e.g., first region AR1 in FIG. 6) may be determined to compensate the phase error in the region (e.g., first region AR 1 in FIG. 6). For example, the target cell gap may be the second cell gap C2. In FIG. 6, a first point A1 and a second point A2 are a start point and an end point of the first region AR1, respectively.

In the first preliminary liquid crystal Fresnel lens having the first cell gap C1, the phase error of the first region AR1 may be greater than a predetermined reference value. Thus, the first region AR1 of the first preliminary liquid crystal Fresnel lens may be determined as a target region in which the first cell gap C1 should be changed to compensate the phase error. In addition, other regions, in which phase errors occur, of the first preliminary liquid crystal Fresnel lens may be determined as the target regions in which cell gaps should be changed. The second cell gap C2 may be a value that causes the smallest phase error in the first region AR1.

Further, a liquid crystal Fresnel lens 130 is formed to have the second cell gap C2, which is different from the first cell gap C1, in the first region AR1.

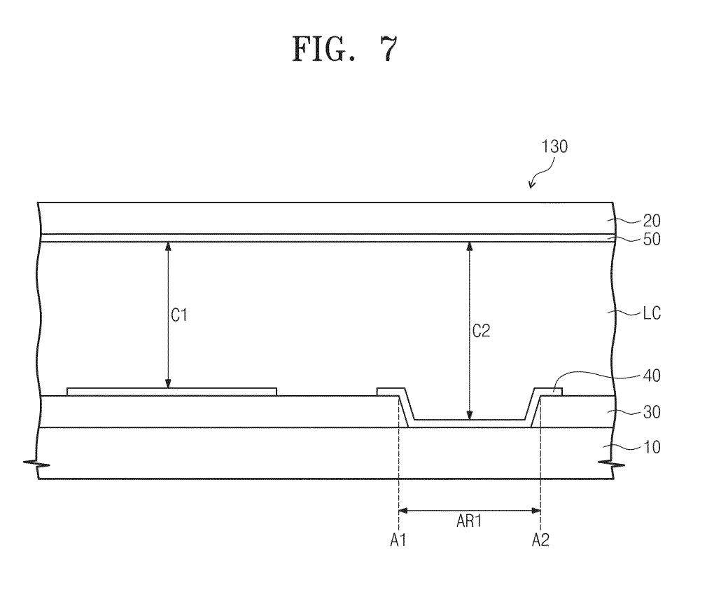

FIG. 7 is a cross-sectional view illustrating the liquid crystal Fresnel lens 130 in which the first cell gap C1 is changed to the second cell gap C2 in the first region AR1.

Referring to FIG. 7, to form the liquid crystal Fresnel lens 130, an insulating material layer having a uniform thickness is formed on a first substrate 10. In addition, for example, a portion of the insulating material layer, which is disposed in the first region AR1, may be removed by a patterning process to form an insulating layer 30 of FIG. 7 having the second cell gap C2 in the first region AR1. Alternatively, the insulating layer 30 in the first region AR1 may be partially removed to form the second cell gap C2 in the first region AR1. In this case, the insulating layer 30 in the first region AR1 may be thinner than the insulating layer 30 in the rest region.

In addition, a transparent electrode layer is formed on the first substrate 10 and/or the insulating layer 30, and the transparent electrode layer is patterned to form a lens electrode 40.

In addition, a common electrode 50 is formed on a second substrate 20. A seal pattern (not shown) may be formed on an edge of the second substrate 20.

The first substrate 10 and the second substrate 20 are bonded to each other, and a liquid crystal layer LC is formed between the first substrate 10 and the second substrate 20.

For example, the liquid crystal Fresnel lens 130 may have the second cell gap C2 in the first region AR1 and the first cell gap C1 in the rest region other than the first region by the shape of the insulating layer 30. Alternatively, the liquid crystal Fresnel lens 130 may have a cell gap different from the first cell gap C1 in at least a portion of the rest region.

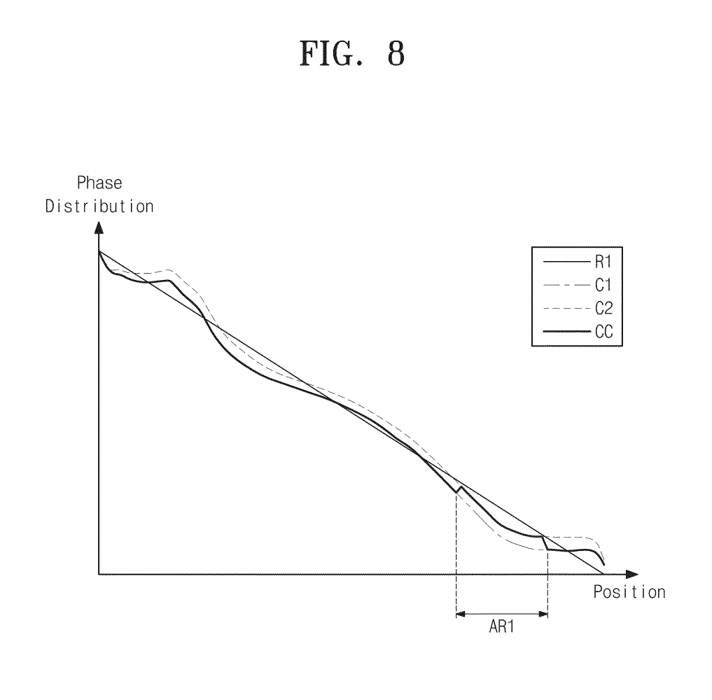

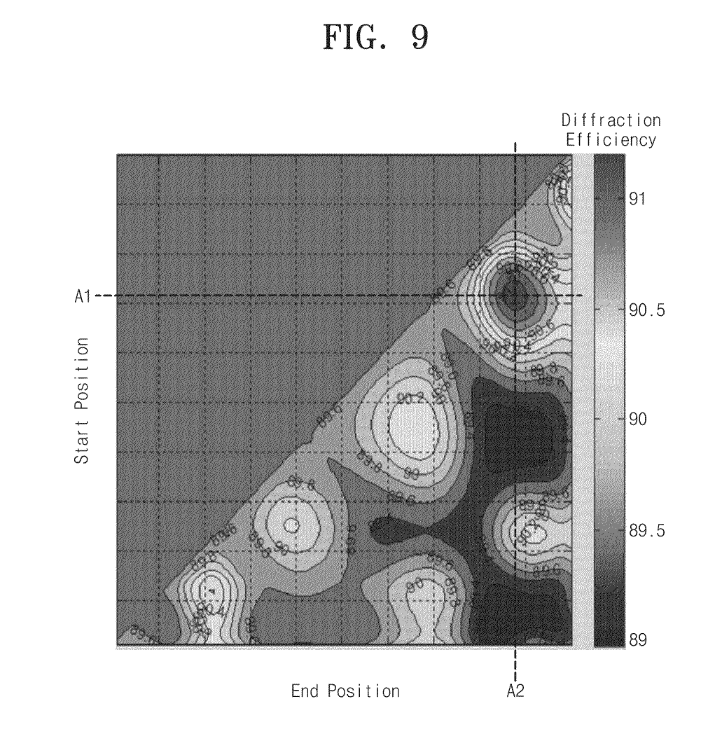

FIG. 8 is a graph illustrating the reference phase R1, the phase distributions C1 and C2 of the first and second liquid crystal Fresnel lenses, and a phase distribution CC of the first liquid crystal Fresnel lens after phase compensation, and FIG. 9 illustrates a diffraction efficiency of the first liquid crystal Fresnel lens after the phase compensation. For example, the phase compensation may be performed on the first liquid crystal Fresnel lens having the uniform first cell gap C1 by changing the first cell gap C1 to a target cell gap (e.g., second cell gap C2) in a target region (e.g., first region AR1).

Referring to the first region AR1 of FIG. 8, the phase distribution CC of the first liquid crystal Fresnel lens after the phase compensation is substantially the same as the phase distribution C2 of the second preliminary liquid crystal Fresnel lens in the first region AR1. Thus, a phase error of the liquid crystal Fresnel lens after the phase compensation may be reduced than that of the first preliminary liquid crystal Fresnel lens having the first cell gap C1.

Referring to FIG. 9, a diffraction efficiency of the first liquid crystal Fresnel lens 130 after the compensation in the first region AR1 between the first point A1 and the second point A2 is higher than that of the liquid crystal Fresnel lens 130 in a region around the first region AR 1. The start and end positions in FIG. 9 are start and end positions of a region under observation for the diffraction efficiency of the first liquid crystal Fresnel lens 130 after the compensation.

According to an exemplary embodiment of the present inventive concept, the phase error and the diffraction efficiency of the liquid crystal Fresnel lenses may be reduced and increased, respectively.

According to an exemplary embodiment of the present inventive concept, the liquid crystal Fresnel lenses having a reduced phase error and an increased diffraction efficiency may be manufactured.

Although the present inventive concept has been described with reference to exemplary embodiments thereof, it will be apparent to those skilled in the art that various modifications may be made therein without departing from the spirit and scope of the present inventive concept as defined by the following claims.

What is claimed is:

1. A liquid crystal Fresnel lens comprising:
a first substrate;
a second substrate facing the first substrate;
an insulating layer disposed on the first substrate;
a plurality of lens electrodes disposed on the first substrate and spaced apart from each other;
a common electrode disposed on the second substrate;
a liquid crystal layer disposed between the first substrate and the second substrate; and
a first region and a second region having cell gaps different from each other.

2. The liquid crystal Fresnel lens of claim 1, wherein the insulating layer is formed in the first region but is not formed in the second region.

3. The liquid crystal Fresnel lens of claim 1, wherein the insulating layer has a first thickness in the first region and a second thickness different from the first thickness in the second region.

4. The liquid crystal Fresnel lens of claim 1, wherein the liquid crystal Fresnel lens includes a plurality of lens regions, and
wherein widths of the lens regions become smaller as distances between the lens regions and a center of liquid crystal Fresnel lens become greater.

5. The liquid crystal Fresnel lens of claim 4, wherein each of the lens regions includes a plurality of sub-regions, and
wherein widths of the sub-regions become smaller as distances between the sub-regions and the center of liquid crystal Fresnel lens become greater.

6. The liquid crystal Fresnel lens of claim 5, wherein each of the lens electrodes corresponds to each of the sub-regions, and
wherein widths of the lens electrodes and distances between the lens electrodes become smaller as distances between the lens electrodes and the center of liquid crystal Fresnel lens become greater.

7. The liquid crystal Fresnel lens of claim 1, wherein the insulating layer comprises:
a first insulating layer formed on the first substrate; and
a second insulating layer disposed on the first insulating layer,
wherein the lens electrodes comprise:
a plurality of first lens electrodes disposed between the first and second insulating layers, wherein the plurality of first lens electrodes is arranged in a first direction and spaced apart from each other; and
a plurality of second lens electrodes disposed on the second insulating layer, wherein the plurality of second lens electrodes is arranged in the first direction and spaced apart from each other.

8. The liquid crystal Fresnel lens of claim 7, wherein the second insulating layer is formed in the first region but is not formed in the second region.

9. The liquid crystal Fresnel lens of claim 7, wherein the second insulating layer has a first thickness in the first region and is formed to have a second thickness different from the first thickness in the second region.

10. The liquid crystal Fresnel lens of claim 7, wherein the first lens electrodes and the second lens electrodes do not overlap each other and are alternately arranged in the first direction.

11. A method of manufacturing a liquid crystal Fresnel lens, the method comprising:
preparing a preliminary liquid crystal Fresnel lens having a first cell gap;
analyzing a phase distribution of the preliminary liquid crystal Fresnel lens;
determining a second cell gap and a first region of the preliminary liquid crystal Fresnel lens in which the first cell gap will be changed into the second cell gap based on the analyzed phase distribution of the preliminary liquid crystal Fresnel lens; and
forming the liquid crystal Fresnel lens having the second cell gap different from the first cell gap in the first region.

12. The method of claim 11, wherein the analyzing of the phase distribution of the preliminary liquid crystal Fresnel lens comprises simulating a designed data value of the preliminary liquid crystal Fresnel lens or measuring a phase distribution of a test product of the preliminary liquid crystal Fresnel lens.

13. The method of claim 11, wherein the first region is determined by detecting a position in which a difference between the phase distribution of the preliminary liquid crystal Fresnel lens and a reference phase is greater than a predetermined reference value.

14. The method of claim 11, wherein the forming of the liquid crystal Fresnel lens comprises:
forming an insulating material layer having a uniform thickness on a first substrate;
patterning a portion of the insulating material layer corresponding to the first region to form an insulating layer having different thicknesses from each other in the first region and a second region;
forming one or more lens electrodes on the first substrate;
forming a common electrode on a second substrate; and
forming a liquid crystal layer between the first substrate and the second substrate.

15. The method of claim 11, wherein the forming of the liquid crystal Fresnel lens comprises:
forming an insulating material layer having a uniform thickness on a first substrate;
removing a portion of the insulating material layer corresponding to the first region to form an insulating layer;
forming one or more lens electrodes on the first substrate;
forming a common electrode on a second substrate; and
forming a liquid crystal layer between the first substrate and the second substrate.

16. The method of claim 11, wherein a difference between a phase caused by the second cell gap and a reference phase in the first region is smaller than a difference between a phase caused by the first cell gap and the reference phase in the first region.

17. A display device comprising:
a liquid crystal Fresnel lens; and
a display panel,
wherein the liquid crystal Fresnel lens comprises:
a first region and a second region arranged in a first direction; and
a liquid crystal layer having a first cell gap in the first region and a second cell gap in the second region;
wherein the first and second cell gaps are different from each other, and
wherein an arrangement state of the liquid crystal layer is changed by an electric field applied to the liquid crystal layer.

18. The display device of claim 17, wherein the liquid crystal Fresnel lens further comprises an insulating layer on which the liquid crystal layer is disposed, wherein the first and second cell gaps are adjusted by changing thicknesses of the insulating layer in the first and second regions.

19. The display device of claim 17, wherein the liquid crystal Fresnel lens further comprises an insulating layer formed in the first region but not formed in the second region.

20. The display device of claim 18, wherein the liquid crystal Fresnel lens further comprises:
a first substrate;
a second substrate facing the first substrate;
a plurality of lens electrodes disposed on the first substrate and spaced apart from each other; and
a common electrode disposed on the second substrate.
